(19) United States
(12) Patent Application Publication
(10) Pub. No.: US 2026/0337213 A1
(43) Pub. Date: Oct. 29, 2026

(54) CATALYTIC DESYMMETRIZING ASYMMETRIC HALOGENATION ENABLES FACILE ACCESS TO AXIALLY CHIRAL BIARYL PHOSPHINE LIGANDS

(71) Applicant: The Chinese University of Hong Kong, Hong Kong (CN)

(72) Inventors: Ying Yeung YEUNG, Hong Kong (CN); Zhiqian YU, Hong Kong (CN)

(21) Appl. No.: 19/659,186

(22) Filed: Apr. 27, 2026

Related U.S. Application Data
(60) Provisional application No. 63/794,422, filed on Apr. 25, 2025.

(51) Int. Cl. C07F 9/50; B01J 31/02

(52) U.S. Cl. CPC C07F 9/509; B01J 31/0232; B01J 31/0258; B01J 2231/40; B01J 2531/002

(57) ABSTRACT

The subject invention pertains to a novel cross-assembly bifunctional catalytic method for highly atroposelective halogenation of biaryl monophosphine oxides. The method discloses a novel asymmetric desymmetrization approach providing a direct and efficient route to access highly enantioenriched axially chiral biaryl monophosphine oxides. These versatile products can be readily reduced to produce chiral SPhos-type ligands with intricate skeletal backbones. Additionally, the halogen handles enable late-stage modifications via cross-coupling reactions, facilitating the synthesis of a diverse array of privileged biaryl monophosphine cores. The utility of these chiral ligands is further exemplified through their application in asymmetric catalysis. The method allows the development of a new class of biaryl monophosphine cores with broad potential in asymmetric catalytic transformations.

### CROSS-REFERENCE TO RELATED APPLICATION

The present application claims the benefit of U.S. Provisional Application Ser. No. 63/794,422, filed Apr. 25, 2025, which is hereby incorporated by reference herein in its entirety, including any figures, tables, or drawings.

### BACKGROUND OF THE INVENTION

Asymmetric catalysis is a cornerstone of modern synthetic chemistry, providing significant commercial value across multiple industries by enabling the efficient, selective, and sustainable production of chiral molecules [1]. Chiral phosphine ligands are indispensable in transition metal asymmetric catalysis due to their ability to induce chirality, enhance catalytic activity, and provide versatility and selectivity [2]. Their importance is underscored by their widespread use in the synthesis of pharmaceuticals, agrochemicals, and fine chemicals, as well as ongoing innovations in ligand design and catalyst optimization [3].

The design and development of chiral phosphine ligands have significantly advanced transition-metal-catalyzed reactions. By independently tuning their steric and electronic properties, these ligands allow precise control over the coordination environment of the metal center, optimizing the catalytic complex's efficiency at different stages of the catalytic cycle. Among these ligands, C₁-symmetric axially chiral biaryl monophosphines have established themselves as highly effective chiral inducers in a variety of metal-catalyzed enantioselective transformations [4]. Notable examples of these chiral ligands include MOP-type [5], KenPhos [6], QUINAP [7], and SPhos-type derivatives [8-15] (FIG. 1A). However, the synthesis of these ligands typically involves either chiral resolution or the use of commercially available BINOL precursors (FIG. 1A). Chiral resolutions are not only challenging when it comes to optimize resolution conditions for novel ligands but also sometimes necessitate the use of stoichiometric amounts of precious metals, rendering it less appealing for the development of new ligand frameworks. Alternatively, relying on chiral BINOLs as starting materials significantly limits the diversity of ligands that can be synthesized. Besides the above strategies, transition-metal-catalyzed asymmetric cross-coupling reactions have also been applied to the synthesis of such chiral ligands, with representative examples including palladium-catalyzed Suzuki-Miyaura [2] coupling and nickel-catalyzed reductive coupling reactions [16]. However, alkyl and sterically demanding aryl phosphine oxides resulted in reduced yields and lower enantioselectivities in these transformations.

Recently, significant progress has been achieved in the development of asymmetric halogenation reactions, leveraging a diverse array of organocatalysis [17-18]. These reactions have garnered considerable attention for their dual capability to introduce a halogen atom that facilitates downstream derivatization while concurrently imparting chirality to the molecule. However, existing studies have primarily focused on the asymmetric halogenation of alkenes [19-20],with relatively limited research on the asymmetric halogenation of aromatic compounds. In the reported cases, substrates featuring a hydrogen bond donor as a directing group are commonly used and have proven successful in asymmetric halogenation of some arenes. [21-25] (FIG. 1B). In these transformations, the substrate, chiral catalyst, and brominating agent can form an orderly linkage through hydrogen bonding, thereby facilitating asymmetric bromination reactions (FIG. 1C, Int I). In contrast, substrates lacking hydrogen bond donors are unable to effectively connect with the brominating agent through the catalyst, making it difficult to achieve asymmetric bromination (FIG. 1C, Int II). This requirement limits the substrate scope of asymmetric halogenation for aromatic compounds, underscoring the challenge of achieving catalytic asymmetric halogenation without hydrogen bond donor groups. Therefore, there is a strong need for the development of efficient and practical synthetic routes to access structurally diverse axially chiral biaryl monophosphines.

### BRIEF SUMMARY OF THE INVENTION

Disclosed herein is a novel method for catalytic desymmetrizing asymmetric halogenation of biaryl monophosphine oxides. In embodiments, the method comprises contacting reactant achiral biaryl monophosphine oxides with an achiral co-catalyst agent in the presence of a chiral phosphoric acid catalyst under process condition, to prepare a chiral SPhos-type ligand. In embodiments, the process conditions further comprise a Molecular Sieves, 5 Å (5 Å MS) and a solvent. In embodiments, the achiral biaryl monophosphine ligand is a hydrogen bond acceptor. In certain embodiments, the catalyst is a chiral phosphoric acid (CPA) bearing a 9-anthracenyl group. In certain embodiments, the co-catalyst agent is preferably tribromophenol. In some embodiments, the chiral asymmetric SPhos-type phosphine oxides can be reduced and functionally derivatized via C—Br bond modifications to prepare an (R)-SPhos-FG-type ligand. In certain embodiments, the (R)-SPhos-FG-type ligand can be further used for asymmetric catalytic transformations.

### BRIEF DESCRIPTION OF THE DRAWINGS

FIGS. 1A-1D illustrate methods for the preparation of axially chiral biaryl phosphine ligands and asymmetric halogenation of aromatic compounds. FIG. 1A illustrates known synthetic strategies for axially chiral biaryl monophosphine ligands and prominent examples. FIG. 1B illustrates literature examples of asymmetric halogenation of aromatic compounds. FIG. 1C illustrates the challenge of achieving catalytic asymmetric halogenation of aromatic compounds without hydrogen bond donor groups and the design in this invention. FIG. 1D shows how catalytic desymmetrizing asymmetric halogenation enables access to axially chiral biaryl phosphine ligands.

FIG. 2 illustrates reaction development. Reactions were carried out with S1 (0.05 mmol), catalyst (0.005 mmol), co-catalyst, additive, NBS (1.05 equiv) in solvent (2 mL) in the absence of light at stated temperature for 48 h. The e.e. was determined by HPLC on a Daicel Chiralpak IC column and the yields were determined by ¹H NMR with CH₂Br₂ as the internal standard. Isolated yield.

FIG. 3 illustrates substrate scope. Unless otherwise noted, all reactions were carried out with phosphine oxide (0.05 mmol), CPA-4 (0.005 mmol), M-8 (0.05 mmol), 5 Å MS (30 mg), NBS (0.525 mmol) in toluene (2 mL) in the absence of light at −20 °C for 48 h. The e.e. was determined by HPLC and the yields were isolated yields.

FIG. 4 illustrates product diversification.

FIGS. 5A-5C illustrate the application of the new ligands in asymmetric catalysis.

### DETAILED DISCLOSURE OF THE INVENTION

### Selected Definitions

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The phrases “consisting essentially of” or “consists essentially of” indicate that the claim encompasses embodiments containing the specified materials or steps and those that do not materially affect the basic and novel characteristic(s) of the claim.

The term “about” means within an acceptable error range for the particular value as determined by one of ordinary skill in the art, which depends in part on how the value is measured, i.e., the limitations of the measurement system. In the context of compositions containing amounts of ingredients where the term “about” is used, these compositions contain the stated amount of the ingredient with a variation (error range) of 0-10% around the value (X±10%). In other contexts, the term “about” is providing a variation (error range) of 0-10% around a given value (X ±10%). As is apparent, this variation represents a range that is up to 10% above or below a given value, for example, X±1%, X±2%, X±3%, X±4%, X±5%, X±6%, X±7%, X±8%, X±9%, or X±10%.

In the present disclosure, ranges are stated in shorthand to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, combinations and subcombinations of ranges (e.g., subranges within the disclosed range) and specific embodiments therein are explicitly included.

By “reduces” is meant a negative alteration of at least 1%, 5%, 10%, 25%, 50%, 75%, or 100%.

By “increases” is meant as a positive alteration of at least 1%, 5%, 10%, 25%, 50%, 75%, or 100%.

As used herein, the terms “determining,” “measuring,” and “assessing,” and “assaying” are used interchangeably and include both quantitative and qualitative determinations.

As used herein, the “enantiomeric excess” or “e.e.” is the measurement of purity used for chiral substances describing the excess of one enantiomer over the other in a mixture of enantiomers.

As used herein, “halogenation” is the replacement of one or more hydrogen atoms in an organic compound by a halogen. A “halogen” is defined as fluorine, chlorine, bromine, or iodine. As used herein, “chlorination” is the halogenation using a chlorine-containing chemical. As used herein, “bromination” is the halogenation using a bromine-containing chemical.

As used herein, a “cross-coupling reaction” is a reaction in which two different starting materials, each of which is usually endowed with an activating group, are reacted together using a catalyst. The cross-coupled reaction can result in the loss of the activating groups and a new covalent bond between the remaining fragments.

### Methods for Asymmetric Halogenation of Aromatic Compounds

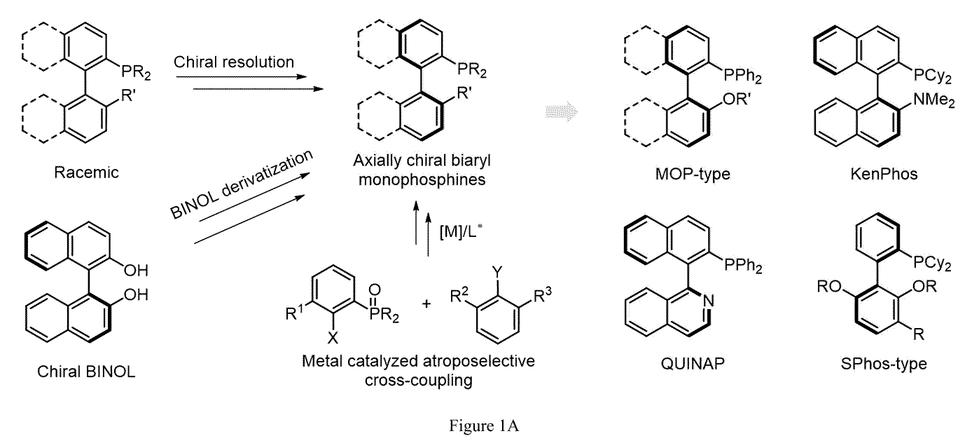

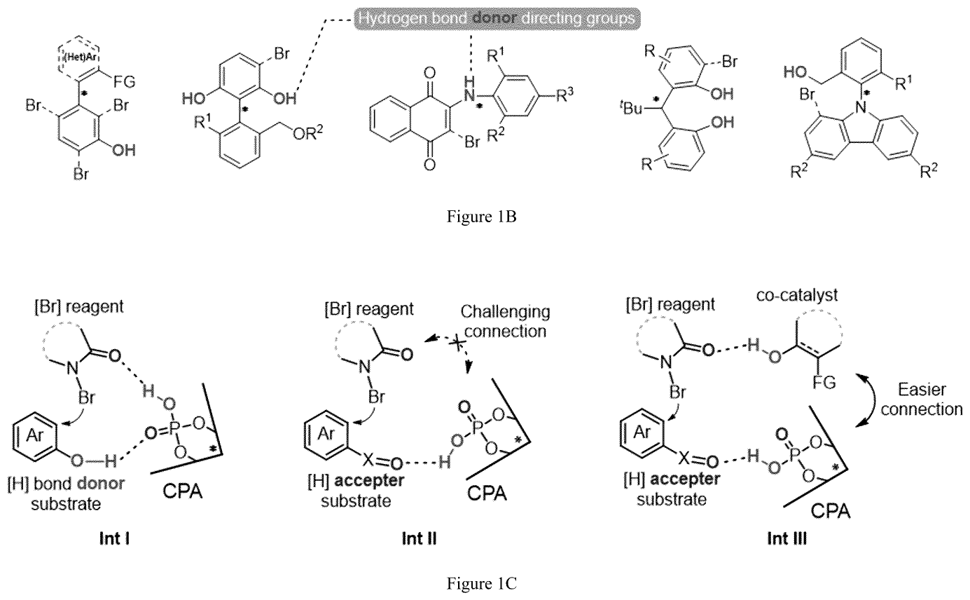

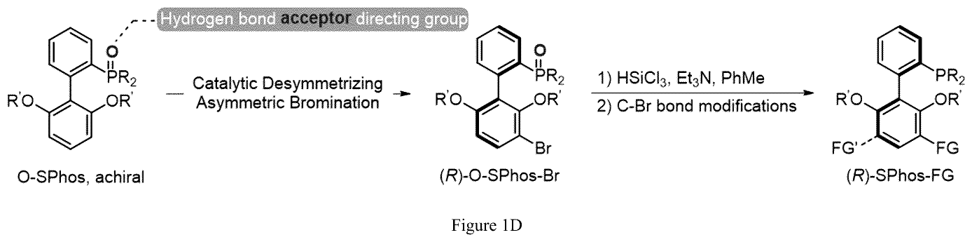

The subject invention pertains to a novel method for catalytic desymmetrizing asymmetric halogenation of biaryl monophosphine oxides. In embodiments, the instant method utilizes a cross-assembly bifunctional catalytic system in asymmetric halogenation reactions employing an achiral co-catalyst. In embodiments, a co-catalyst serves as an additional bridge between the chiral catalyst and the brominating agent, enhancing the reaction's efficiency and selectivity. (FIG. 1C, Int III).

In embodiments, the novel cross-assembly bifunctional catalytic method combines a chiral catalyst, for example, chiral phosphoric acid (CPA) bearing a 9-anthracenyl group, and an achiral co-catalyst, for example, tribromophenol, to achieve efficient and highly selective asymmetric halogenation of biaryl compounds, with phosphine oxides as directing groups (FIG. 1D). In embodiments, the process condition for the reaction of the instant method includes, for example, a solvent. In some examples, the solvent includes, but is not limited to, CS₂, CCl₄, and toluene. In preferred embodiments, the solvent is toluene. Additionally, in certain embodiments, a molecular sieve (M.S.) is used. The M.S. can have a pore size of about 0.1 Å to about 100 Å, about 1 Å to about 10 Å, or about 5 Å. In certain embodiments, the process condition is carried out at a temperature of about −80 °C, −60 °C, −40 °C, −20 °C, 0 °C, 20 °C, 25 °C, 40 °C or greater. In preferred embodiments, the process can be performed at a temperature less than or equal to −20 °C. The temperature can be determined by a variety of factors including reaction time, reagent concentrations, and desired products and/or product concentrations. In certain embodiments, the reactions of the subject invention can be performed for at least 1 hour, 2 hours, 3 hours, 4 hours, 8 hours, 12 hours, 24 hours, 2 days, 3 days, 4 days, 5 days, 6 days, 7 days, 10 days or longer. The length of time can be determined by a variety of factors including temperature, reagent concentrations, and desired products and/or product concentrations. In preferred embodiments, the duration of the reaction is about 48 hours.

In certain embodiments, the chiral phosphoric acid catalyst is provided in a concentration of about at least 0.1 mol %, 1 mol %, 2 mol %, 2.5 mol %, 3 mol %, 3.5 mol %, 4 mol %, 4.5 mol %, 5 mol %, 5.5 mol %, 6 mol %, 6.5 mol %, 7 mol %, 7.5%, 10 mol %, or greater relative to the achiral phosphine oxide reactant, and the achiral co-catalyst is provided at a concentration of about 0.1, 0.2, 0.4, 0.6, 0.8, 1.0, 1.2 or greater equivalents.

In the process of this invention, the source of halogen may be provided, for example, as elemental halogen, hydrogen halide, or any electrophilic halogen chemical, including any inorganic or organic halogen-containing compound or mixture of such compounds that is capable of transferring its halogen atom(s) to the reactant phosphine oxide. Suitable, non-limiting examples of a source of halogen include bromine, N-bromosuccinimide (NBS), N-bromophthalimide (NBP), Nbromoacetamide (NBA), 1,3-dibromo-5,5-dimethylhydantoin (DBDMH), 1,3-dibromo-5,5-diphenylhydantoin (DBDPH), 2,4,4,6-tetrabromo-2,5-cyclohexadienone (TBCO), chlorine, Nchlorosuccinimide (NCS), N-chlorophthalimide (NCP), 1,3-dichloro-5,5-dimethylhydantoin (DCDMH), 1,3-dichloro-5,5-diphenylhydantoin (DCDPH), 1-(4-methylbenzoyl)-3-chloro-5,5-diphenylhydantoin, iodine, and N-iodosuccinimide. Typically, the amount of halogen source will vary depending upon the specific process stoichiometry, the reactor design, and safety considerations. Alternatively, the source of halogen may be used in an amount that is greater or less than the stoichiometric amount, if desired. In preferred embodiments, the source of halogen may be used in a stoichiometric amount. In certain embodiments, the concentration of the source of the halogen can be at least 0.01 mmol, 0.05 mmol, 0.1 mmol, 0.15 mmol, 0.2 mmol, 0.21 mmol, 0.25 mmol, 0.3 mmol, 0.35 mmol, 0.4 mmol, 0.45 mmol, 0.5 mmol, 1 mmol or greater.

In certain embodiments, the reaction's e.e. affords products with yields of not less than 80%, preferably from about 81% to 90%, more preferably from about 91% to about 95%, most preferably more than 95% and with e.e. ranging from about 84% to about 100%, preferably more than 95%, more preferably from 96% to 99%, most preferably about 99%.

The novelty of the subject method consists in the use of asymmetric halogenation of aromatic compounds directed by hydrogen bond acceptors. In embodiments, the instant method can easily convert inexpensive achiral phosphine ligands into high value chiral phosphine ligand. In addition, in preferred embodiments, the halogen handles allow for late-stage modification of the ligand, allowing for the easy derivatization to give a variety of chiral phosphine ligand library. The method offers a potential breakthrough by enabling more efficient and scalable production of these valuable ligands, unlocking new opportunities for their widespread adoption in the chemical and pharmaceutical industries.

In embodiments, the substrate includes, but is not limited to, an achiral biaryl monophosphine ligand. In embodiments, the achiral biaryl monophosphine ligand is in oxide form. In certain embodiments, any achiral biaryl monophosphine oxide that is a hydrogen bond acceptor can be used as a substrate. In some examples, the non-chiral substrates encompass a broad range of dialkylphosphine oxides and diarylphosphine oxides of biaryl monophosphine oxide scaffolds. Representative substituents include, but is not limited to, cyclohexyl, cyclopentyl, isopropyl, tert-butyl, 1-adamantyl, as well as phenyl, substituted phenyl, and naphthyl groups. The biaryl backbone can be further functionalized with various groups including, but is not limited to, alkyl, aryl, alkoxy, trifluoromethyl, trifluoromethoxy, benzyl, cyano and halogens. The biaryl framework itself is not restricted to simple phenyl-phenyl linkages but may also incorporate extended and heteroaromatic systems such as naphthyl, anthracenyl, and indolyl rings, thereby expanding the scope of π-conjugation and potential noncovalent interactions. Additionally, the oxygen atom is functionalized with alkyl chains of varying lengths and steric demands, providing further structural flexibility for ligand optimization.

In certain embodiments, the chiral asymmetric SPhos-type ligand can be reduced and then functionally derivatized. In a specific example, a reduced SPhos-type ligand includes, for example, (R)-SPhos-Br, which can be derivatized via C—Br bond modifications to prepare an (R)-SPhos-FG-type ligand. In some examples, the reduced and functionally derivatized ligand includes, but is not limited to, (R)-SPhos-acid (e.g., (R)-SPhos-CO₂H), (R)-SPhos-sulfonate salt (e.g. (R)-SPhos-SO₃Na), (R)-SPhos-phosphine (e.g., (R)-SPhos-PPh₂), (R)-SPhos-aryl (e.g., (R)-SPhos-Ph, (R)-SPhos-Ant), (R)-SPhos-alkyl (e.g. (R)-SPhos-Me, (R)-SPhos-ⁿBu), and (R)-SPhos-silane (e.g., (R)-SPhos-TMS). The reductive reaction of phosphine oxide uses additional reagents. The reagents include trichlorosilane, triethylamine, and toluene. The substituted (R)-SPhos is defined by the substitution of the halogen handle by other chemicals such as, for example, boronic acids. The cross-coupling reaction uses additional reagents. The reagents include boronic acids, such as, but not limited to, 9-anthraceneboronic acid, methylboronic acid, and n-butylboronic acid, salt such as, but not limited to, potassium phosphate tribasic, other reagents, such as, but not limited to, n-butyllithium, carbon dioxide, sulfuryl chloride, chlorodiphenylphosphine, and chlorotrimethylsilane. An additional solvent, such as for example toluene and tetrahydrofuran. The chemical reagents in the cross-coupling reaction can be processed by reflux for about 2 hours to about 48 hours, about 8 hours to about 36 hours, or about 18 hours to about 24 hours. In certain embodiments, the cross-coupling reaction is performed at a temperature of at least −80 °C, −78 °C, −60 °C, −40 °C, −25 °C, −20 °C, 0 °C, 20 °C, 23 °C, 25 °C, 80 °C or greater. In certain embodiments, the cross-coupling reaction is performed in stages in which chemical reactants are added or removed; additionally, the temperature or reaction time is changed throughout the process. In recent years, chiral phosphine ligands have played a crucial role in metal-catalyzed asymmetric transformations, offering limitless possibilities for the efficient construction of chiral compounds. Despite the fact that chiral brominated SPhos analogs are not yet commercially available, their counterparts, such as chiral BIDIME (CAS: 1373432-09-7) and KenPhos (CAS: 255882-16-7), are priced as high as USD$1,620 per gram and USD$400 per gram, respectively.

Moreover, derivatives of products of the subject invention can be used to synthesize chiral SPhos-based sulfonic acids [8, 9, 10], phosphoric acids [11], carboxylic acids [12, 13], and amino acid derivatives [14, 15]. The application of these derivatives in asymmetric synthesis has gained widespread recognition in recent years. However, the commercialization of these high-value chiral phosphine ligands has long been hindered by their reliance on chiral resolution for synthesis. The method of the subject invention offers a potential breakthrough by enabling more efficient and scalable production of valuable ligands, unlocking new opportunities for their widespread adoption in the chemical and pharmaceutical industries.

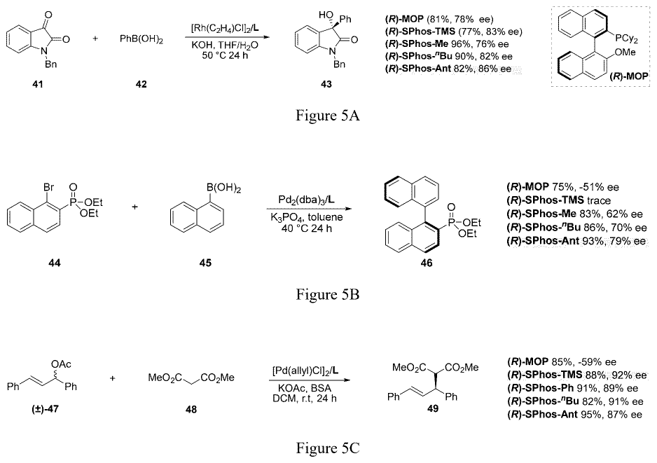

In certain examples, asymmetric catalytic transformations include, but are not limited to, addition reaction, asymmetric Suzuki-Miyaura coupling reaction, or asymmetric Tsuji-Trost reaction. Notably, ligand (R)-SPhos-Ant demonstrated exceptional enantioselectivity in isatin addition reaction (FIG. 5A) and asymmetric Suzuki-Miyaura reaction (FIG. 5B). In contrast, ligand (R)-SPhos-TMS exhibited outstanding enantioselectivity (92% ee) in the asymmetric Tsuji-Trost reaction (FIG. 5C).

In certain embodiments the chiral phosphine ligands include, but are not limited to, chiral phosphine ligands (R)-SPhos-Ant or (R)-SPhos-TMS, which can be used in catalyzed asymmetric addition of phenylboronic acid to isatin, asymmetric Suzuki-Miyaura coupling reactions and asymmetric Tsuji-Trost reaction. In certain embodiments, the chiral phosphine ligand is present at a concentration of at least 0.1 mol %, 1 mol %, 2 mol %, 2.5 mol %, 3 mol %, 3.5 mol %, 4 mol %, 4.5 mol %, 5 mol %, 5.5 mol %, 6 mol %, 6.5 mol %, 7 mol %, 7.5%, 10 mol %, or greater. In certain embodiments, a chiral phosphine ligand such as, for example, THF is used in the catalysis reaction at a concentration of about 0.001M to about 10M, about 0.0025M to about 2.5M, about 0.01M to about 1.0M, about 0.025M to about 0.25M, or about 0.025M to about 0.1M. The e.e. of the resulting adduct can be up to 92% e.e. In certain embodiments, the reaction is performed at a temperature of at least −80 °C, −60 °C, −40 °C, −20 °C, 0 °C, 20 °C, 25 °C, 40 °C or greater for about 30 mins to about 48 hours.

### MATERIALS AND METHODS

### Synthesis of Chiral Asymmetric Sphos-Type Ligands

To a solution of biaryl monophosphine oxides (0.01 mmol, 0.05 mmol, 0.1 mmol, 0.15 mmol, 0.2 mmol, 0.21 mmol, 0.25 mmol, 0.3 mmol, 0.35 mmol, 0.4 mmol, 0.45 mmol, 0.5 mmol, 1 mmol or greater), chiral phosphoric acid catalyst (at least 0.1 mol %, 1 mol %, 2 mol %, 2.5 mol %, 3 mol %, 3.5 mol %, 4 mol %, 4.5 mol %, 5 mol %, 5.5 mol %, 6 mol %, 6.5 mol %, 7 mol %, 7.5%, 10 mol %, or greater), achiral co-catalyst (about 0.1, 0.2, 0.4, 0.6, 0.8, 1.0, 1.2 or greater equivalents) and 5 Å MS in toluene or CCl₄ (0.01M to about 1.0M) was added halogenating agent (0.01 mmol, 0.05 mmol, 0.1 mmol, 0.15 mmol, 0.2 mmol, 0.21 mmol, 0.25 mmol, 0.3 mmol, 0.35 mmol, 0.4 mmol, 0.45 mmol, 0.5 mmol, 1 mmol or greater) at −80 °C, −78 °C, −60 °C, −40 °C, −25 °C, −20 °C, 0 °C, 20 °C, 23 °C, 25 °C, 80 °C or greater temperature in the absence of light. The resultant mixture was stirred for at least 1 hour, 2 hours, 3 hours, 4 hours, 8 hours, 12 hours, 24 hours, 2 days, 3 days, 4 days, 5 days, 6 days, 7 days, 10 days or longer time and quenched with saturated aqueous Na₂SO₃ solution (2 mL). The solution was extracted with EtOAc (3×5 mL). The combined organic layer was dried over anhydrous Na₂SO₄ and concentrated under reduced pressure. The residue was subjected to flash column chromatography (hexane/EtOAc 1:1—CHCl₃/EtOAc 1:3) to afford the chiral halogenated SPhos-type phosphine oxide products.

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Example 1—Reaction Development

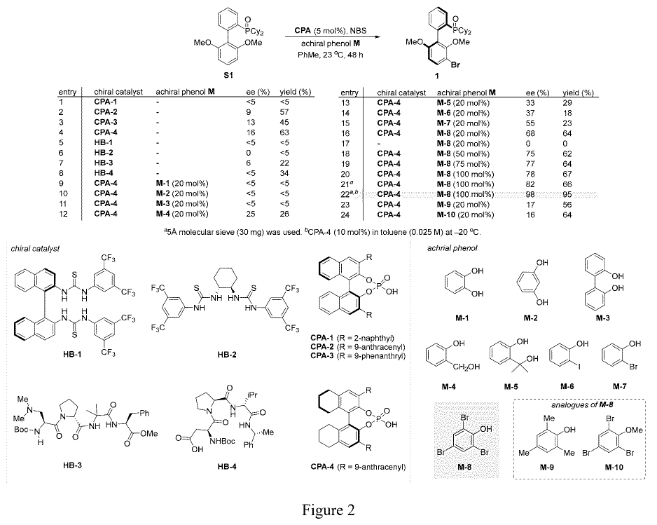

SPhos, a premier ligand for challenging Suzuki-Miyaura coupling reactions, was therefore selected in its oxide form (FIG. 2, S1) as the model substrate. Besides, toluene, a non-polar solvent with excellent solubility and a low melting point, was considered an ideal choice for our exploration of asymmetric halogenation reactions. We initiated our exploration of the reaction by screening chiral phosphoric acids intoluene at 23 °C. After extensive optimization, we found that CPA with π-extended substituents exhibited promising enantioselectivity (FIG. 2, entries 1-4). Notably, A number of known acid-acid HB bifunctional catalysts, such as bis-thioureas (HB-1,HB-2) and oligopeptides (HB-3, HB-4) were also studied. However, the results were found to be unsatisfactory (FIG. 2, entries 5-8). We next sought to identify a suitable achiral co-catalyst to achieve optimal enantioselectivity. The introduction of aryl diols, such as catechol (M-1), resorcinol (M-2), and bisphenol M-3, did not improve the enantioselectivity (FIG. 2, entries 9-11). However, using achiral diol M-4 (25% ee) and M-5 (33% ee) as the phenol additives resulted in a significant enhancement in the asymmetric performance (FIG. 2, entries 12-13). Further study revealed that halophenols M-6 and M-7, which we believe could serve as halogen bond (XB) donors, gave good ee of the desired product 1 (FIG. 2, entries 14-15). The use of phenolic additives M-1-M-7 consistently led to diminished yields compared to the case with CPA-4 alone, likely due to consumption of the halogen source by the phenols, as evidenced by the detection of brominated phenols in the reactions. To circumvent the undesired bromination side pathway, tribromophenol M-8 was employed, and good yield and ee were obtained (entry 16). Phenol M-8 alone showed no catalytic effect (FIG. 2, entry 17). The increasing the loading of M-8 from 20 to 100 mol % led to a significant improvement in enantioselectivity from 61% to 78% ee (FIG. 2, entries 18-20). Optimization of the reaction by tuning the physical parameters, additive, and amount of achiral phenol led to the excellent enantioselectivity (98% ee) of product 1 (FIG. 2, entries 21-22). The analogues of M-8, including M-9 (no Br) and M-10 (with OH masked in the form of OMe), were studied and their results were far inferior (FIG. 2, entries 23-24), indicating that both OH and Br in M-8 are important in the additive design.

### Example 2—Substrate Scope

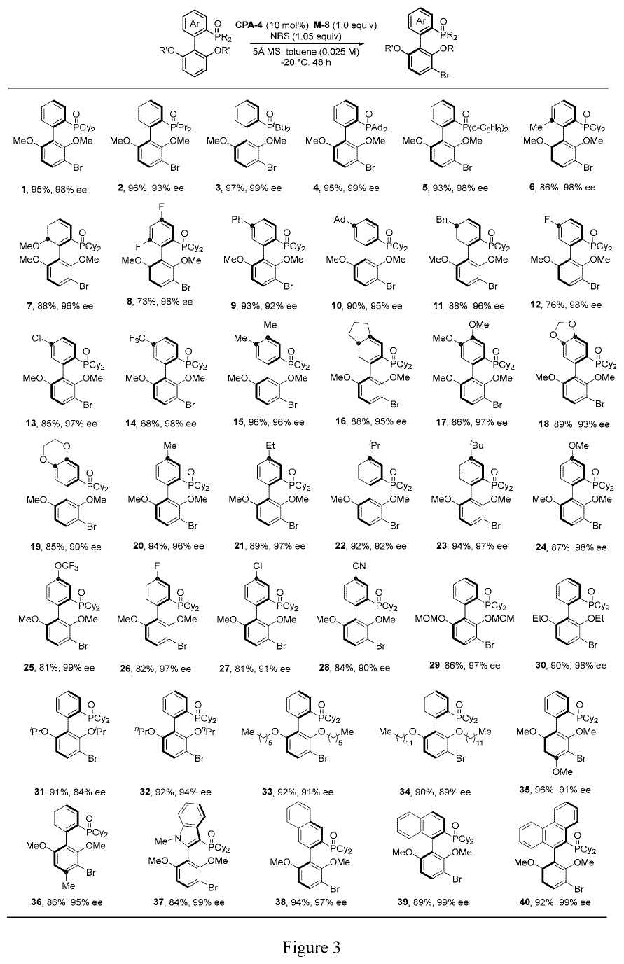

Next, the scope of phosphine oxides was systematically explored (FIG. 3). Gratifyingly, the reaction demonstrated exceptional substrate generality and functional group tolerance. Substrates bearing bulky phosphine oxide groups, such as cyclohexyl, cyclopentyl, isopropyl, tert-butyl, and even 1-adamantyl, delivered products with excellent yields and stereoselectivity (FIG. 3, 1-5). Remarkably, product 1 could be obtained on a 2 mmol scale with a 95% yield and 98% ee, while catalyst CPA-4 was efficiently recovered with an 85% yield, highlighting the potential of this transformation for industrial applications. Substrates with electron-donating groups like alkyl, phenyl, alkoxy, trifluoromethoxy, benzyl as well as electron-withdrawing groups like halogens, trifluoromethyl, cyano positioned at various sites on the biaryl framework, consistently afforded products with outstanding yields and excellent e.e. (FIG. 3, 6-28, 35-36). It is worth noting that some substrates bearing electron-withdrawing groups required an extended reaction time of up to 5 days to achieve satisfactory yields (FIG. 3, 8, 12-14, 26-28). For substrate bearing an ortho-methoxy group relative to the reactive site, the reaction temperature was lowered to −60 °C to suppress background reaction (FIG. 3, 35). In some cases, the use of TBCO/CCl₄ instead of NBS/toluene was necessary to achieve optimal stereoselectivity (FIG. 3, 14, 17-19, 31). While the introduction of a sterically demanding isopropyl group on the oxygen atom significantly diminished the reaction's e.e. (FIG. 3, 31), substrates with long alkyl chains or a MOM group posed no such challenges (FIG. 3, 29-34). Furthermore, naphthalene, phenanthrene, and indole-based frameworks were well-tolerated, affording axially chiral biaryl phosphine oxide compounds with diverse skeletons (FIG. 3, 37-40).

### Example 3—Product Diversification and Application

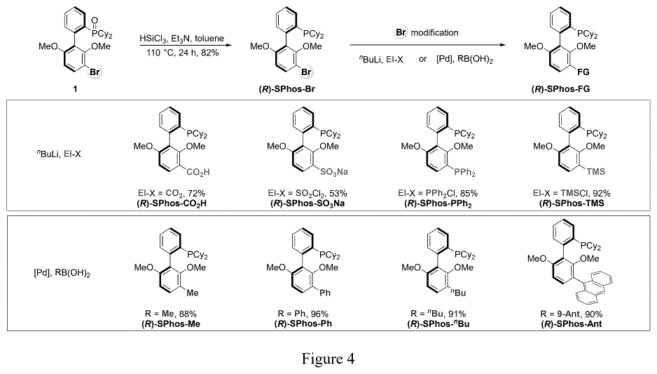

To explore the catalytic potential of this class of axially chiral phosphine ligands in asymmetric transformations, we carried out the reduction and functional derivatization of compound 1 (FIG. 4). The reduction of the phosphine oxide was efficiently achieved using trichlorosilane in the presence of triethylamine, yielding (R)-SPhos-Br with an 82% yield. Subsequently, the bromine atom was successfully transformed into a carboxylic acid ((R)-SPhos-CO₂H) and a sulfonic acid ((R)-SPhos-SO₃Na), both of which were proved to enhance the selectivity in reactions through ionic interactions. Furthermore, the introduction of diphenylphosphine resulted in the synthesis of a structurally unique axially chiral bidentate phosphine ligand, (R)-SPhos-PPh₂. Notably, the steric properties of the functional groups could be flexibly tuned, ranging from small groups such as phenyl ((R)-SPhos-Ph) and methyl ((R)-SPhos-Me) to bulkier groups like butyl ((R)-SPhos-ⁿBu), trimethylsilyl ((R)-SPhos-TMS), and anthracenyl ((R)-SPhos-Ant). This remarkable tunability allows the ligand to be readily customized to meet the specific demands of various catalytic reactions.

We subsequently carried out preliminary investigations to evaluate the performance of these newly synthesized ligands in a series of common catalytic transformations. For comparison, the commercially available ligand (R)-MOP was included as a benchmark. Notably, the anthracene-substituted ligand (R)-SPhos-Ant demonstrated exceptional enantioselectivity in both the addition reaction between isatin and phenylboronic acid (FIG. 5A), as well as in asymmetric Suzuki-Miyaura coupling reactions (FIG. 5B), affording the corresponding products with yields of 82% and 93% and ee of 86% and 79%, respectively. In contrast, the trimethylsilyl-containing ligand (R)-SPhos-TMS exhibited outstanding enantioselectivity (92% ee) in the asymmetric Tsuji-Trost reaction (FIG. 5C). By comparison, the catalytic performance of the commercial ligand (R)-MOP was consistently suboptimal across these reactions.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### EXEMPLARY EMBODIMENTS

Embodiment 1 A catalytic desymmetrizing asymmetric halogenation method, the method comprising contacting a reactant achiral biaryl monophosphine ligand with an achiral co-catalyst agent in the presence of a chiral catalyst under process conditions, to prepare a chiral asymmetric SPhos-type ligand.

Embodiment 2 The method of embodiment 1, wherein a Molecular Sieves (M.S.) is included in the process conditions, wherein the M.S. has a pore size ranging from about 0.1 Å to about 100 Å.

Embodiment 3 The method of embodiment 1 or 2, wherein the achiral biaryl monophosphine ligand is a hydrogen bond acceptor ligand.

Embodiment 4 The method of any preceding embodiment, wherein the achiral biaryl monophosphine ligand is in oxide form.

Embodiment 5 The method of any preceding embodiment, wherein the achiral biaryl monophosphine oxide is alkyl, phenyl, alkoxy, trifluoromethoxy, benzyl, cyclohexyl, cyclopentyl, isopropyl, tert-butyl, 1-adamantyl, naphthalene, phenanthrene, or indole-based framework.

Embodiment 6 The method of any preceding embodiment, wherein the achiral co-catalyst agent is tribromophenol.

Embodiment 7 The method of any preceding embodiment, wherein the chiral catalyst is a chiral phosphoric acid (CPA) bearing a 9-anthracenyl group.

Embodiment 8 The method of any preceding embodiment, wherein the process conditions comprise the presence of a solvent, and the process occurs at a temperature ranging from about −80 °C to about 40 °C

Embodiment 9 The method of embodiment 8, wherein the solvent is CS₂, CCl₄, or toluene.

### Embodiment 10 the Method of Embodiment 9, Wherein the Solvent Is Toluene.

Embodiment 11 The method of any preceding embodiment, wherein the process conditions comprise a time ranging from about 1 hour to about 10 days.

Embodiment 12 The method of any preceding embodiment, wherein the chiral catalyst is provided in a concentration of about 10 mol % or in a stoichiometrically amount relative to the achiral phosphine ligand reactant, and the co-catalyst is provided at a concentration of about 1.05 equivalents.

Embodiment 13 The method of any preceding embodiment, wherein the chiral asymmetric SPhos-type ligand is reduced and then functionally derivatized.

Embodiment 14 The method of embodiment 13, wherein the reduced chiral asymmetric SPhos-type ligand comprises (R)-SPhos-Br.

Embodiment 15 The method of embodiment 14, wherein the (R)-SPhos-Br ligand is functionally derivatized via C—Br bond modifications to prepare an (R)-SPhos-FG-type ligand.

Embodiment 16 The method of embodiment 15, wherein the (R)-SPhos-FG-type ligand is (R)-SPhos-acid, (R)-SPhos-sulfonate salt, (R)-SPhos-phosphine, (R)-SPhos-aryl, (R)-SPhos-alkyl, or (R)-SPhos-silane.

Embodiment 17 The method of embodiment 15 or 16, wherein the (R)-SPhos-FG-type ligand is further used for asymmetric catalytic transformations selected from addition reaction, asymmetric Suzuki-Miyaura coupling reaction, or asymmetric Tsuji-Trost reaction.

Embodiment 18 The method of any preceding embodiment, wherein the reaction's yield is not less than 80% and the e.e. ranges from about 84% to about 100%.

Embodiment 19 The method of any preceding embodiment, wherein the reaction's yield is not less than 95% and the e.e. ranges from about 95% to about 100%.

Embodiment 20 The method of any preceding embodiment, wherein the reaction's yield is not less than 95% and the e.e. is not less than 97%.

### REFERENCES

1. 1. Akiyama, T. et al. Catalytic Asymmetric Synthesis. 4^{th} ed. Wiley: New York (2022). doi.org/10.1002/9781119736424
2. Tang, W. et al. Chiral Monophosphorus Ligands for Asymmetric Catalytic Reactions. ACS Catal. (2016) 6, 4814. doi.org/10.1021/acscatal.6b01001
3. Imamoto, T. P-Stereogenic Phosphorus Ligands in Asymmetric Catalysis. Chem. Rev. (2024) 124, 8657. doi.org/10.1021/acs.chemrev.3c00875
4. Hayashi, T. Chiral Monodentate Phosphine Ligand MOP for Transition-Metal-Catalyzed Asymmetric Reactions. Acc. Chem. Res. (2000) 33, 354. doi.org/10.1021/ar990080f
5. Uozumi, Y et al. Catalytic asymmetric synthesis of optically active 2-alkanols via hydrosilylation of 1-alkenes with a chiral monophosphine-palladium catalyst. J. Am. Chem. Soc. (1991), 113, 9887. doi.org/10.1021/ja00026a044
6. Alcock, N. W. et al. Synthesis and resolution of 1-(2-diphenylphosphino-1-naphthyl)isoquinoline; a P-N chelating ligand for asymmetric catalysis. Tetrahedron Asym. (1993), 4, 743. doi.org/10.1016/S0957-4166(00)80183-4
7. Uozumi, Y. et al. Synthesis of optically active 2-(diarylphosphino)-1,1′-binaphthyls, efficient chiral monodentate phosphine ligands. J. Org. Chem. (1993), 58, 1945-1948, DOI: 10.1021/jo00059a059
8. Pearce-Hiigins, R. et al. An Enantioselective Suzuki-Miyaura Coupling to Form Axially Chiral Biphenols. J. Am. Chem. Soc. (2022) 144, 33, 15026-15032. doi.org/10.1021/jacs.2c06529
9. Kadarauch, M. et al. sSPhos: A General Ligand for Enantioselective Arylative Phenol Dearomatization via Electrostatically-Directed Palladium Catalysis. J. Am. Chem. Soc. (2023) 145, 25553. doi.org/10.1021/jacs.3c10663
10. Kadarauch, M. et al. Intermolecular Asymmetric Arylative Dearomatization of 1-Naphthols. J. Am. Chem. Soc. (2024), 146, 34970. doi.org/10.1021/jacs.4c14754
11. Lou, Y. et al. Distal Ionic Substrate-Catalyst Interactions Enable Long-Range Stereocontrol: Access to Remote Quaternary Stereocenters through a Desymmetrizing Suzuki-Miyaura Reaction. J. Am. Chem. Soc. (2022) 144, 123. doi.org/10.1021/jacs.1c12345
12. Li, M. et al. Mechanically Planar Chiral Rotaxanes through Catalytic Desymmetrization. Chem (2022) 8, 2843. doi.org/10.1016/j.chempr.2022.08.009
13. Li, M. et al. Inherently chiral resorcinarene cavitands through ionic catalyst-controlled cross-coupling. Chem (2024), 10, 3323. doi.org/10.1016/j.chempr.2024.06.012
14. Wei, J. et al. Amino Acid-Derived Ionic Chiral Catalysts Enable Desymmetrizing Cross-Coupling to Remote Acyclic Quaternary Stereocenters. J. Am. Chem. Soc. (2023) 145, 16796. doi.org/10.1021/jacs.3c04877
15. Liu, C. et al. Ion Hydration Enables Generality in Asymmetric Catalysis: Desymmetrization to P-Stereogenic Triarylphosphine Derivatives. Angew. Chem. Int. Ed. (2025), e202417827. doi/org/10.1002/anie.202417827
16. Kim, R. S. et al. Nickel-Catalyzed Atroposelective Cross-Electrophile Coupling of Aryl Halides: A General and Practical Route to Diverse MOP-Type Ligands. J. Am. Chem. Soc. (2024) 146, 17606. doi.org/10.1021/jacs.4c04608
17. Xiang, S.-H. et al. Advances in asymmetric organocatalysis over the last 10 years. Nat. Commun. (2020) 11, 3786. doi.org/10.1038/s41467-020-17580-z
18. Yan, J. et al. The applications of catalytic asymmetric halocyclization in natural product synthesis. Org. Chem. Front., (2022) 9, 499. doi.org/10.1039/D1QO01395E
19. Denmark, S.E. et al. Catalytic, asymmetric halofunctionalization of alkenes-a critical perspective. Angew. Chem. Int. Ed. (2012) 51, 10938. doi.org/10.1002/anie.201204347
20. Cheng, Y. A. et al. Recent advances in asymmetric intra-and intermolecular halofunctionalizations of alkenes. Org. Biomol. Chem. (2014) 12, 2333. doi.org/10.1039/C3OB42335B
21. Gustafson, J. L. et al. Dynamic Kinetic Resolution of Biaryl Atropisomers via Peptide-Catalyzed Asymmetric Bromination. Science (2010) 328, 1251. doi.org/10.1126/science.1188403
22. Mori, K. et al. Enantioselective Synthesis of Multisubstituted Biaryl Skeleton by Chiral Phosphoric Acid Catalyzed Desymmetrization/Kinetic Resolution Sequence. J. Am. Chem. Soc. (2013) 135, 3964. doi.org/10.1021/ja311902f
23. Vaidya, S. D. et al. Catalytic Atroposelective Synthesis of N-Aryl Quinoid Compounds. J. Am. Chem. Soc. (2020) 142, 2198. doi.org/10.1021/jacs.9b12994
24. Xiong, X. et al. Access to Chiral Bisphenol Ligands (BPOL) through Desymmetrizing Asymmetric Ortho-Selective Halogenation. Chem (2020) 6, 919. doi.org/10.1016/j.chempr.2020.01.009
25. Huang, J. et al. Desymmetrizing atroposelective bromination of N-arylcarbazoles enabled by cross-assembled bifunctional catalysts. Chem (2025) 11, 102439. doi.org/10.1016/j.chempr.2025.102439

We claim:

1. A catalytic desymmetrizing asymmetric halogenation method, the method comprising contacting a reactant achiral biaryl monophosphine ligand with an achiral co-catalyst agent in the presence of a chiral catalyst under process conditions, to prepare a chiral asymmetric SPhos-type ligand.

2. The method of claim 1, wherein a Molecular Sieves (M.S.) is included in the process conditions, wherein the M.S. has a pore size ranging from about 0.1 Å to about 100 Å.

3. The method of claim 1, wherein the achiral biaryl monophosphine ligand is a hydrogen bond acceptor ligand.

4. The method of claim 1, wherein the achiral biaryl monophosphine ligand is in oxide form.

5. The method of claim 4, wherein the achiral biaryl monophosphine oxide is alkyl, phenyl, alkoxy, trifluoromethoxy, benzyl, cyclohexyl, cyclopentyl, isopropyl, tert-butyl, 1-adamantyl, naphthalene, phenanthrene, or indole-based framework.

6. The method of claim 1, wherein the achiral co-catalyst agent is tribromophenol.

7. The method of claim 1, wherein the chiral catalyst is a chiral phosphoric acid (CPA) bearing a 9-anthracenyl group.

8. The method of claim 1, wherein the process conditions comprise the presence of a solvent, and the process occurs at a temperature ranging from about −80 °C to about 40 °C.

9. The method of claim 8, wherein the solvent is CS₂, CCl₄, or toluene.

10. The method of claim 9, wherein the solvent is toluene.

11. The method of claim 1, wherein the process conditions comprise a time ranging from about 1 hour to about 10 days.

12. The method of claim 1, wherein the chiral catalyst is provided in a concentration of about 10 mol % or in a stoichiometrically amount relative to the achiral phosphine ligand reactant, and the co-catalyst is provided at a concentration of about 1.05 equivalents.

13. The method of claim 1, wherein the chiral asymmetric SPhos-type ligand is reduced and then functionally derivatized.

14. The method of claim 13, wherein the reduced chiral asymmetric SPhos-type ligand comprises (R)-SPhos-Br.

15. The method of claim 14, wherein the (R)-SPhos-Br ligand is functionally derivatized via C—Br bond modifications to prepare an (R)-SPhos-FG-type ligand.

16. The method of claim 15, wherein the (R)-SPhos-FG-type ligand is (R)-SPhos-acid, (R)-SPhos-sulfonate salt, (R)-SPhos-phosphine, (R)-SPhos-aryl, (R)-SPhos-alkyl, or (R)-SPhos-silane.

17. The method of claim 15, wherein the (R)-SPhos-FG-type ligand is further used for asymmetric catalytic transformations selected from addition reaction, asymmetric Suzuki-Miyaura coupling reaction, or asymmetric Tsuji-Trost reaction.

18. The method of claim 1, wherein the reaction's yield is not less than 80% and the e.e. ranges from about 84% to about 100%.

19. The method of claim 18, wherein the reaction's yield is not less than 95% and the e.e. ranges from about 95% to about 100%.

20. The method of claim 19, wherein the reaction's yield is not less than 95% and the e.e. is not less than 97%.
